(19) United States
(12) Patent Application Publication
(10) Pub. No.: US 2026/0367576 A1
(43) Pub. Date: Nov. 19, 2026

(54) WATCH COMPRISING A HOROLOGY MOVEMENT COMPRISING AN EARTH PHASE AND EARTHRISE DISPLAY DEVICE

(71) Applicant: ETA SA Manufacture Horlogère Suisse, Grenchen (CH)

(72) Inventor: Stéphane BACHMANN, Büren an der Aare (CH)

(73) Assignee: ETA SA Manufacture Horlogère Suisse, Grenchen (CH)

(21) Appl. No.: 19/652,378

(22) Filed: Apr. 20, 2026

(30) Foreign Application Priority Data
May 16, 2025 (EP) 25177073.1

(51) Int. Cl. G04B 19/26; G04B 19/02

(52) U.S. Cl. CPC G04B 19/26; G04B 19/02

(57) ABSTRACT

A watch (10) including a horology movement including a finishing gear train and an Earth phase and Earthrise display device (100). The display device includes a display (110) with a display wheel (111) bearing a graphical representation of the Earth (112) and being movable about a rotational axis of the display (110); a mask wheel (120) rotatably movable along an axis coinciding with the rotational axis of the display wheel (111) and integrally rotating with a mask (121) arranged to alternately conceal and reveal the graphical representation of the Earth (112); and a reduction gear train (130) kinematically connecting the finishing gear train with the display (110). The device is configured such that the display wheel (111) and the mask (120) are rotated at different average speeds upon completing a turn of the display wheel (111).

### CROSS REFERENCE TO RELATED APPLICATIONS

This application claims priority based on European Patent Application No. 25177073.1 filed on May 16, 2025, the entire contents of which are incorporated herein by reference.

### TECHNICAL FIELD OF THE INVENTION

The invention relates to the field of horology and in particular to devices for displaying a time value on a timepiece.

More specifically, the invention relates to an Earth phase and Earthrise display device for the horology movement in a watch. The display device is capable of indicating which part of the Earth is visible from the Moon, and in particular of indicating the phases of the Earth as they would be perceived by an observer from the Moon.

### TECHNOLOGICAL BACKGROUND

In the field of horology, particularly with regard to horological complications, it may be desirable to offer unexpected or commemorative displays so that the aesthetic appearance of the watch is particularly distinctive and attractive. Visual animation is one of the many solutions provided.

Moon phase displays are quite common in the field of horology, as are Earth phase displays, in other words, displays of the part of the Earth visible from the Moon.

Moon or Earth phase display devices considerably complicate the horology movement into which they are incorporated.

The invention meets the need to display an attractive Earth phase.

### SUMMARY OF THE INVENTION

The present invention aims to enable the Earth phase and the part of the Earth's surface that can be seen by an observer orbiting the Moon, i.e., the Earthrise, to be indicated simultaneously in a single dial aperture.

To this end, the invention relates to a watch comprising a horology movement comprising a finishing gear train and an Earth phase and Earthrise display device. The Earth phase and Earthrise display device comprises: - a display comprising a display wheel bearing at least one graphical representation of the Earth and being rotatably movable about an axis, wherein the display further comprises a mask wheel rotatably movable along an axis coinciding with the axis of rotation of the display wheel and integrally rotating with a mask arranged to alternately conceal and reveal the graphical representation of the Earth, - a reduction gear train kinematically connecting the finishing gear train with the display,

wherein the Earth and Earth survey phase display device is configured such that the display wheel and the mask are rotated at different average speeds upon completing a turn of the display wheel.

In particular embodiments, the invention can further comprise one or more of the following features, taken separately or in any technically possible combination.

In particular embodiments, a star is attached to the display wheel in a rotatably moveable manner, wherein the star is kinematically connected to the mask wheel.

In particular embodiments, a jumper is attached to the display wheel and engages with the star.

In particular embodiments, the star is configured to engage once a day with a stop attached to a twenty-four-hour wheel of the horology movement when the display is rotationally driven so as to transmit a discontinuous rotational movement to the mask wheel.

In particular embodiments, the star is connected to the mask wheel by a transmission gear train sized to drive the mask wheel by half turn less than the display wheel in 29.53 days.

In particular embodiments, the Earth phase and Earthrise display device comprises a drive wheel in contact with the mask wheel and engaging with a twenty-four-hour wheel of the horology movement.

In particular embodiments, the mask wheel is kinematically connected to a correction wheel connected to a control element such that when the control element is actuated by a user, it causes the mask wheel to rotate.

In particular embodiments, the display wheel and the mask wheel are continuously rotationally driven by a mobile element of the reduction gear train at different reduction ratios.

In particular embodiments, the display wheel and the mask wheel are continuously rotationally driven by two wheels of the same mobile element of the reduction gear train.

In particular embodiments, the display comprises an intermediate wheel coaxially mounted and rotationally free relative to the display wheel and the mask wheel, comprising a first and a second stage rotating as one piece. The first stage engages with the reduction gear train, and the second stage is kinematically connected, via a ratchet mechanism, to the display wheel. The ratchet mechanism is configured to transmit a torque generated by the intermediate wheel to the display wheel, and to release when a torque is generated by the display wheel.

In particular embodiments, the display wheel is kinematically connected to a correction wheel connected to a control element such that when the control element is actuated by a user, it causes the display wheel to rotate.

### BRIEF DESCRIPTION OF THE FIGURES

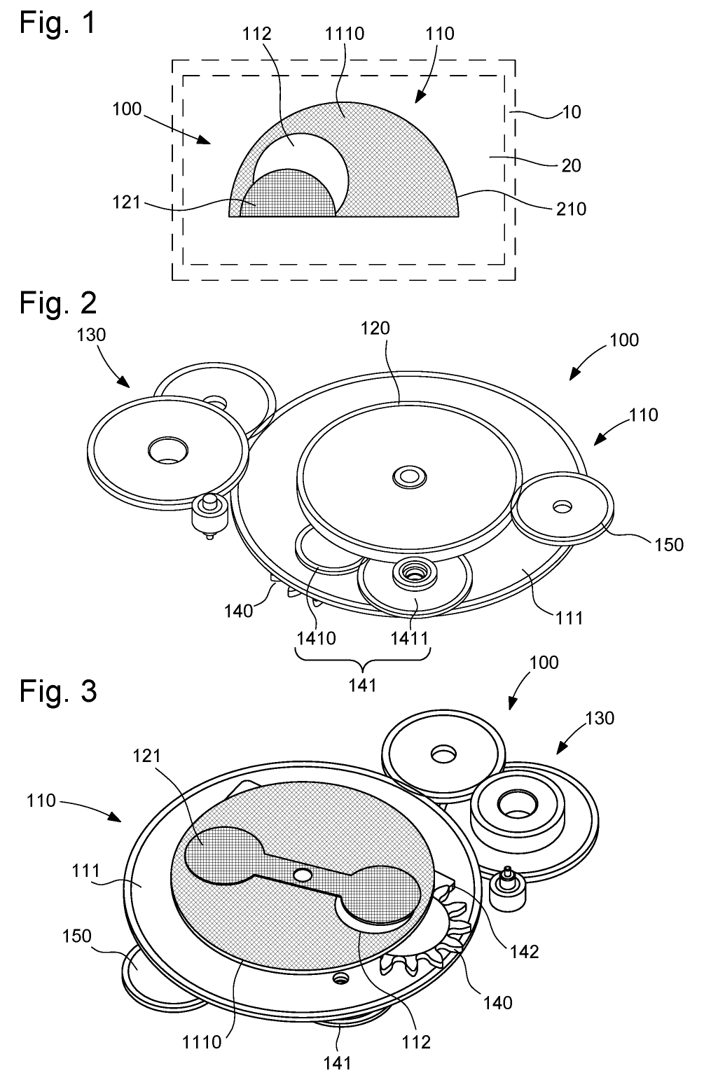

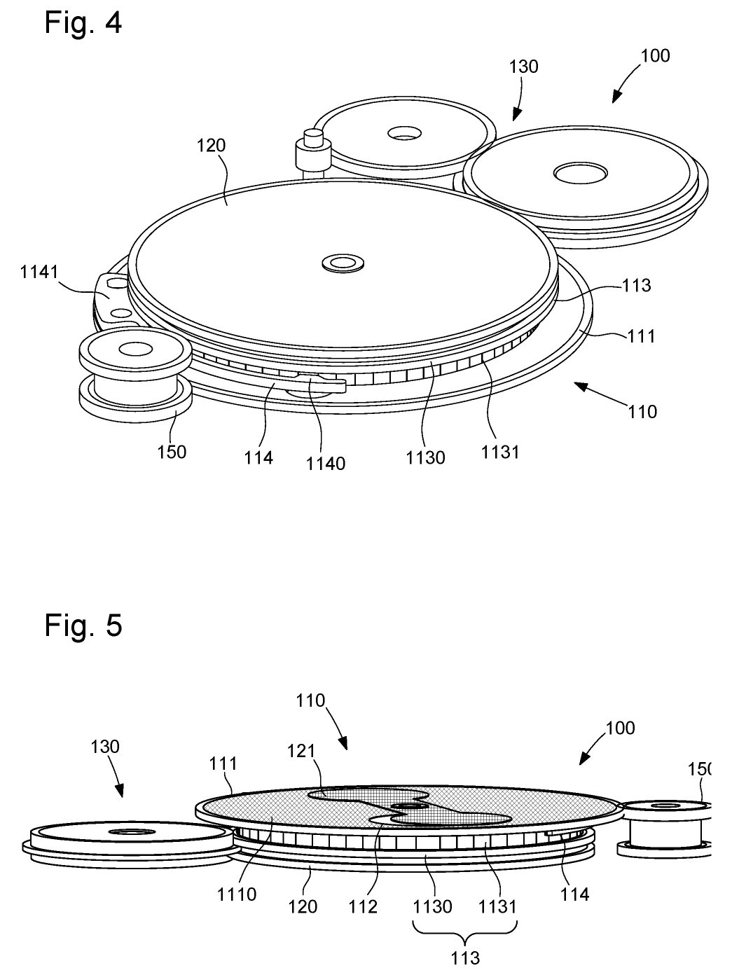

Other features and advantages of the invention will become apparent from the following detailed description, given by way of non-limiting example, with reference to the attached drawings in which: - FIG. 1 shows a detail view of a watch dial aperture comprising an Earth phase and Earthrise display device according to an exemplary embodiment of the invention, - FIG. 2 shows a perspective bottom view of an Earth phase and Earthrise display device according to a first exemplary embodiment of the invention, - FIG. 3 shows a perspective top view of the Earth phase and Earthrise display device according to FIG. 2, - FIG. 4 shows a perspective bottom view of an Earth phase and Earthrise display device according to a second exemplary embodiment of the invention, - FIG. 5 shows a perspective side view of the Earth phase and Earthrise display device according to FIG. 4.

It should be noted that the figures are not necessarily drawn to scale for clarity reasons.

### DETAILED DESCRIPTION OF THE INVENTION

The invention relates to a watch 10 comprising a dial 20 and a horology movement comprising a finishing gear train known as such by a person skilled in the art. The finishing gear train is connected to an energy source such as a barrel kinematically connected to a regulating element or such as one or more electric motors.

The watch 10 further advantageously comprises an Earth phase and Earthrise display device 100 comprising a display 110 comprising a display wheel 111 bearing at least one graphical representation of the Earth 112. Alternatively, the display wheel 111 may bear two graphical representations of the Earth 112 diametrically opposed on either side of an axis of rotation of the display wheel 111. In particular, in the exemplary embodiments of the invention depicted in the figures, the display wheel 111 is integral with a disc 1110 that supports it by means of a central shaft, wherein the disc 1110 displays the graphical representation of the Earth 112.

The present invention makes it possible to display the evolution of the part of the Earth visible from the Moon, i.e., an Earthrise, as well as the Earth phase, i.e., the part of the Earth lit by the Sun.

The disc 1110 is arranged opposite an aperture 210 made in the dial 20, such that the graphical representation of the Earth 112 is successively displayed through the aperture 210 upon rotation of the display wheel 111. In particular, in the exemplary embodiment of the invention depicted in FIG. 1, the aperture 210 has a substantially semi-circular shape, such that a portion of the display wheel 111 is hidden behind the dial 20 upon rotation.

Advantageously, the graphical representation of the Earth 112 can represent complementary terrestrial hemispheres, for example the Eastern hemisphere and the Western hemisphere.

The display 110 further comprises a mask wheel 120 that is rotatable relative to the dial 20 and relative to the display wheel 111, along an axis coinciding with the axis of rotation of the display wheel 111. The mask wheel 120 rotates integrally with a mask 121 arranged to alternately conceal and reveal the graphical representation of the Earth 112.

In particular, the mask 121 is formed by at least one opaque area, preferably two, wherein each is capable of concealing the graphical representation of the Earth 112. The mask 121 has, for example, an appearance identical to that of a background on which the graphical representation of the Earth 112 is made, for example a solid colour. In an example not shown in the figures, the mask 121 may include a transparent area for the disc 1110 to appear, formed by a transparent material.

Advantageously, the Earth phase and Earthrise display device 100 comprises a reduction gear train 130 kinematically connecting the finishing gear train, for example an intermediate wheel, with the display 110, in particular with the display wheel 111 and the mask wheel 120, directly or indirectly.

As described in detail in the remainder of the text, the Earth and Earth survey phase display device 100 is configured such that the display wheel 111 and the mask wheel 120 are rotated at different average speeds upon completing a turn of the display wheel 111.

FIGS. 2 and 3 represent an exemplary embodiment of the invention, wherein the reduction gear train 130 is connected to the mask wheel 120 via the display wheel 111.

In the exemplary embodiment shown in FIGS. 2 and 3, a star 140 kinematically connected to the mask wheel 120 is attached to the display wheel 111 in a rotatably moveable manner. As shown in FIGS. 2 and 3, the star 140 is connected to the mask wheel 120 by a transmission gear train 141. A jumper 142, visible in FIG. 3, is attached to the display wheel 111 so as to engage with the star 140.

Due to the star 140 and the transmission gear train 141, the rotation of the display wheel 111 drives the rotation of the mask wheel 120, and therefore the mask 121, in the same direction and at the same speed. This direction of rotation is preferably clockwise.

The difference in average rotational speed between the display wheel 111 and the mask wheel 120 is, in this exemplary embodiment, caused by the star 140. In particular, the star 140 is arranged to engage once a day with a stop, for example formed by a pin, attached to a twenty-four-hour wheel, when the watch is operated, i.e., when the display wheel 111 is rotationally driven, so as to transmit a discontinuous rotational movement to the mask wheel 120 in a direction opposite to the rotational direction of the display wheel 111, i.e., preferentially in the counterclockwise direction. In other words, once a day, the star 140 causes a rotational backward movement of the mask wheel 120 of a predetermined step angle.

In this embodiment, the reduction gear train 130 is sized to drive the display wheel 111, and therefore the disc 1110, at a rotational speed of one turn every two hours. In addition, the star 140 and the transmission gear train 141 are sized to drive the mask wheel 120 in a counterclockwise direction so that the mask 121 makes one half turn less than the display wheel 111 in 29.53 days. Indeed, one cycle of Earth phases is completed in 29.53 days.

As shown in FIGS. 2 and 3, the star 140 is arranged on a side of the display wheel 111 opposite the mask wheel 120 and is interposed between the display wheel 111 and the disc 1110. The transmission gear train 141 is interposed between the display wheel 111 and the mask wheel 120, and is formed by a driving pinion 1410 connected to the star 140 by a common axis, and by a mobile transmission element 1411, whose transmission wheel is engaged with the driving pinion 1410 and whose transmission pinion engages with the mask wheel 120.

It should be noted that the star 140 may, in a variant of this embodiment of the invention, be arranged in the manner of a sun gear i.e., coaxially with the mask wheel 120 and the display wheel 111.

In summary, as can be seen in FIG. 1, when the mask 121 moves against the aperture 210, it can partially or completely cover the graphical representation of the Earth 112. As it rotates, the mask 121 therefore causes a variation in the visible surface of the graphical representation of the Earth 112, and more specifically by alternately increasing and reducing this visible surface.

Thus, the present invention makes it possible to represent the vision of an observer rotating in orbit around the Moon and looking at the Earth. As a result, the watch 10 features a particularly attractive astronomical animation.

Preferentially, the mask wheel 120 is kinematically connected to a correction wheel 150 connected to a control element such that when the control element is actuated by a user, it causes the mask wheel 120 to rotate in the clockwise or counterclockwise direction, for example by one step. The step is defined by rotating the star 140 by an angle such that the jumper 142 engages with two successive teeth of said star 140. Such a control element may be formed by a crown or a button and may be connected to the correction wheel 150 by a correction mechanism similar to that of a date corrector.

Advantageously, rotating the mask 121 when correcting its position is not transmitted to the display wheel 111 since the star 140 is driven rotationally only according to its axis and cannot transmit any movement to the display wheel 111, as the display wheel is locked in position by the reduction gear train 130. Indeed, since the reduction gear train 130 is connected to the finishing gear train, it generates a strong torque causing the display wheel 111 to be held in position.

In another exemplary embodiment, the difference in average rotational speed between the display wheel 111 and the mask wheel 120 could be caused by a drive wheel engaging with a twenty-four-hour wheel of the horology movement and in contact with the mask wheel 120. This drive wheel can be formed, for example, by the correction wheel 150. In this exemplary embodiment, the star 140 and the reduction gear train 130 make it possible to index the rotation of the mask 121. Contrary to the exemplary embodiment described above, the star 140 is therefore not intended to be driven rotationally by a stop attached to a twenty-four-hour wheel. In this exemplary embodiment as well, the star can be arranged in the manner of a sun gear or a planet gear.

FIGS. 4 and 5 represent an exemplary embodiment of the invention wherein the reduction gear train 130 is directly connected to the mask wheel 120.

In particular, the display wheel 111 and the mask wheel 120 are continuously rotationally driven by a mobile element of the reduction gear train 130 at different reduction ratios. Preferentially and as visible in FIG. 5, the display wheel 111 and the mask wheel 120 are continuously rotationally driven in the same direction by two wheels of the same mobile element of the reduction gear train 130. The reduction gear train 130 is sized to drive the display wheel 111 at a rotational speed of one turn every two hours and to drive the mask wheel 120 at a speed such that the mask 121 makes one half turn less than the display wheel 111 in 29.53 days.

In this exemplary embodiment of the invention, the display 110 comprises, in addition to the mask wheel 120 and the display wheel 111, an intermediate wheel 113 coaxially mounted and rotationally free relative to mask wheel and display wheel. The intermediate wheel 113 comprises a first stage 1130 engaging with the reduction gear train 130 and a second stage 1131, with which it rotates integrally. The second stage 1131 is kinematically connected, via a ratchet mechanism 114, to the display wheel 111.

In this exemplary embodiment of the invention, the disc 1110 displaying the graphical representation of the Earth 112 is formed by the display wheel 111, as visible in FIG. 5.

As shown in FIGS. 4 and 5, the ratchet mechanism 114 comprises an elastic blade extending between a free end 1140 engaging with the toothing of the second stage 1131 and an anchoring end 1141 attached to the display wheel 111.

The display wheel 111 may be provided with a through opening opposite the free end 1140. This opening makes it possible to verify that the free end 1140 properly engages with the teeth of the second stage 1131 during assembly of the movement and during subsequent checks.

In this exemplary embodiment of the invention, the display wheel 111 displaying the graphical representation of the Earth 112 is connected to the correction wheel 150.

Advantageously, the ratchet mechanism 114 is configured to transmit a torque generated by the intermediate wheel 113 to the display wheel 111, and to release when a torque is generated by the display wheel 111, which has the effect of not transmitting the movement of the intermediate wheel 113. Indeed, since the reduction gear train 130 is connected to the finishing gear train, it generates a strong torque causing the intermediate wheel 113 to be held in position, and the torque is sufficiently high for the ratchet mechanism 114 to release when the display wheel 111 is rotated.

More specifically, during normal operation of the watch 10, the intermediate wheel 113 is rotationally driven by the reduction gear train 130, and in turn rotationally drives the display wheel 111 via the ratchet mechanism 114. Conversely, rotation of the display wheel 111, when caused by the correction wheel 150 as described below, causes the elastic blade of the teeth of the second stage teeth 1131 to be released, such that no movement is transmitted to the intermediate wheel 113.

In this exemplary embodiment of the invention, the display wheel 111 is therefore engaged with the correction wheel 150 kinematically connected to a control element, such that when the control element is actuated by a user, it causes the display wheel 111 to rotate in the clockwise or counterclockwise direction.

Similar to the first exemplary embodiment described, such a control element may be formed by a crown or a button and may be connected to the correction wheel 150 by a correction mechanism similar to that of a date corrector.

It should be noted that, for the sake of concision of the application, the components of the horology movement known to the person skilled in the art are not described in this present text and do not appear in the figures.

Moreover, it should be noted that the embodiments and uses considered above have been described by way of non-limiting examples, and that other variants are therefore conceivable.

1. A watch (10) comprising a horology movement comprising a finishing gear train and an Earth phase and Earthrise display device (100), wherein the Earth phase and Earthrise display device (100) comprises:
a display (110) comprising a display wheel (111) bearing at least one graphical representation of the Earth (112) and being movable about an axis of rotation of the display (110), wherein the display (110) further comprises a mask wheel (120) rotatably movable along an axis coinciding with the axis of rotation of the display wheel (111) and integrally rotating with a mask (121) arranged to alternately conceal and reveal the graphical representation of the Earth (112); and
a reduction gear train (130) kinematically connecting the finishing gear train with the display (110),
wherein the Earth and Earth survey phase display device (100) is configured such that the display wheel (111) and the mask (121) are rotated at different average speeds upon completing a turn of the display wheel (111).

2. The watch (10) according to claim 1, wherein a star (140) is attached to the display wheel (111) in a rotatably moveable manner, wherein said star (140) is kinematically connected to the mask wheel (120).

3. The watch (10) according to claim 2, wherein a jumper (142) is attached to the display wheel (111) and engages with the star (140).

4. The watch (10) according to claim 3, wherein the star (140) is configured to engage once a day with a stop fixed to a twenty-four-hour wheel of the horology movement when the display (110) is rotationally driven so as to transmit a discontinuous rotational movement to the mask wheel (120).

5. The watch (10) according to claim 4, wherein the star (140) is connected to the mask wheel (120) by a transmission wheel (141) sized to drive the mask wheel (120) by half a turn less than the display wheel (111) in 29.53 days.

6. The watch (10) according to claim 2, wherein the Earth phase and Earthrise display device (100) comprises a drive wheel in contact with the mask wheel (120) and engaging with a twenty-four-hour wheel of the horology movement.

7. The watch (10) according to claim 1, wherein the mask wheel (120) is kinematically connected to a correction wheel (150) connected to a control element such that when the control element is actuated by a user it causes the mask wheel (120) to rotate.

8. The watch (10) according to claim 1, wherein the display wheel (111) and the mask wheel (120) are continuously rotationally driven by a mobile element of the reduction gear train (130) according to different reduction ratios.

9. The watch (10) according to claim 8, wherein the display wheel (111) and the mask wheel (120) are continuously rotationally driven by two wheels of the same mobile element of the reduction gear train (130).

10. The watch (10) according to claim 8, wherein the display (110) comprises an intermediate wheel (113) coaxially mounted and rotationally free relative to the display wheel (111) and the mask wheel (120), and comprising a first and a second stage (1130, 1131) integrally rotating, wherein the first stage (1130) engages with the reduction gear train (130) and the second stage (1131) is kinematically connected, via a ratchet mechanism (114), to the display wheel (111), wherein the ratchet mechanism (114) is configured to transmit a torque generated by the intermediate wheel (113) to the display wheel (111), and to prohibit the transmission of a torque generated by the display wheel (111) to the intermediate wheel (113).

11. The watch (10) according to claim 8, wherein the display wheel (111) is kinematically connected to a correction wheel (150) connected to a control element such that when the control element is actuated by a user, it causes the display wheel (111) to rotate.
